(19) United States
(12) Patent Application Publication
(10) Pub. No.: US 2026/0301734 A1
(43) Pub. Date: Oct. 1, 2026

(54) MODEL LEARNING METHOD, MODEL LEARNING APPARATUS, AND PROGRAM

(71) Applicant: NTT, Inc., Tokyo (JP)

(72) Inventors: Takanori ASHIHARA, Tokyo (JP); Takaaki FUKUTOMI, Tokyo (JP)

(73) Assignee: NTT, Inc., Tokyo (JP)

(21) Appl. No.: 19/479,998

(22) PCT Filed: May 2, 2023
(86) PCT No.: PCT/JP2023/017192

§ 371 Date: Oct. 29, 2025

(51) Int. Cl. G10L 15/16; G10L 15/06; G10L 15/32

(52) U.S. Cl. CPC G10L 15/16; G10L 15/063; G10L 15/32

(57) ABSTRACT

A complicated speech representation is realized by a student model having a model size smaller than that of a teacher model. A model learning method according to one aspect of the present disclosure includes: generating an acoustic feature amount sequence X from a speech digital signal A; generating a teacher model representation sequence Y from the speech digital signal A using a teacher model TM that is a trained model trained by self-supervised learning; and training a student model SM having a model size smaller than a model size of the teacher model TM model using the acoustic feature amount sequence X and the teacher model representation sequence Y.

### TECHNICAL FIELD

The present disclosure relates to knowledge distillation techniques.

### BACKGROUND ART

Self-supervised learning (hereinafter, also referred to as “SSI”) for speech representation is a technique capable of learning speech representation in advance using a large amount of unlabeled speech data. By using the voice representation model trained by SSL, even in a case where only a small amount of labeled voice data can be obtained, tasks (hereinafter, also referred to as a “subsequent task”) such as voice recognition, speaker recognition, and emotion recognition performed as subsequent processing can be solved with high accuracy (see, for example, Non Patent Literature 1).

Generally, in a speech SSL model, a speech waveform is used as an input. On the other hand, regarding a capability with respect to subsequent tasks, there are those with which an accuracy comparable to that with input of speech waveforms can be secured simply by input of a feature amount having spectrum information such as a logarithmic log mel filter bank (hereinafter, also referred to as “FBANK”). However, in order to ensure high accuracy in the subsequent tasks, it is important to acquire a complicated speech representation by utilizing time information and the like included in the speech waveform, and thus the speech waveform is often used for actual input. In this case, a deep convolution layer such as a convolutional neural network 7 (CNN7) layer is provided for pre-processing of an encoder such as a transformer that acquires a complicated speech representation, and a speech waveform sequence is degenerated in many cases.

By using the input of the speech waveform, a highly versatile SSL model is obtained. On the other hand, the Sequence length of the input when inputting speech waveforms is overwhelmingly longer compared with the inputting of feature amounts such as FBANK, which results in a significant increase in calculation costs. Furthermore, by using speech waveforms, in a case where a deep convolution layer is provided, not only do the calculation costs become significant, but also the calculation costs and the processing time for subsequent tasks such as inference increase.

As a method for solving this problem, for example, there is a proposal to compress the model size by knowledge distillation (KD). In the knowledge distillation, a model having a large model size (hereinafter, also referred to as a “teacher model”) is trained in advance, and its rich expression is transferred to a model having a small model size (hereinafter, also referred to as a “student model”), thereby realizing compression of the model size. At this time, since the speech waveform is similarly input in the student model, only the encoder is changed without changing the deep convolution layer (see, for example, Non Patent Literature 2).

### CITATION LIST

### Non Patent Literature

Non Patent Literature 1: A. Mohamed et al., “Self-Supervised Speech Representation Learning: A Review,” in IEEE Journal of Selected Topics in Signal Processing, vol. 16, no. 6, pp. 1179-1210, Oct. 2022, doi: 10.1109/JSTSP.2022.3207050.

Non Patent Literature 2: H.-J. Chang, S.-w. Yang and H. y. Lee, “Distilhubert: Speech Representation Learning by Layer-Wise Distillation of Hidden-Unit Bert,” ICASSP 2022 -2022 IEEE International Conference on Acoustics, Speech and Signal Processing (ICASSP), Singapore, Singapore, 2022, pp. 7087-7091, doi: 10.1109/ICASSP 43922.2022. 9747490.

### SUMMARY OF INVENTION

### Technical Problem

However, since the input used in Non Patent Literature 2 is only a speech waveform, the input sequence length is longer than that of a pre-processed feature amount sequence such as FBANK, and accordingly, it is necessary to form a convolution layer, which is a process of preceding stage of the encoder, deeper. Therefore, there is a problem that the calculation cost and the processing time of the subsequent task are large.

In order to solve the above problem, an object of the present disclosure is to realize a complicated speech representation with a student model having a model size smaller than that of a teacher model.

### Solution to Problem

In order to solve the above problem, a model learning method according to one aspect of the present disclosure includes generating an acoustic feature amount sequence from a speech digital signal; generating a teacher model representation sequence from the speech digital signal using a teacher model that is a trained model trained by self-supervised learning; and training a student model having a model size smaller than a model size of the teacher model using the acoustic feature amount sequence and the teacher model representation sequence.

### Advantageous Effects of Invention

According to the present disclosure, with the above configuration, a complicated speech representation can be realized by a student model having a model size smaller than that of a teacher model.

### BRIEF DESCRIPTION OF DRAWINGS

FIG. 1 is a diagram illustrating a functional configuration example of a model learning device of the present disclosure.

FIG. 2 is a flowchart illustrating an example of processing of a model learning device 1.

FIG. 3 is a diagram illustrating a functional configuration example of a modification of the model learning device of the present disclosure.

FIG. 4 is a flowchart illustrating an example of processing of a model learning device la.

FIG. 5 is a diagram illustrating a functional configuration of a computer.

### DESCRIPTION OF EMBODIMENTS

Hereinafter, an embodiment of the present disclosure will be described in detail with reference to the drawings. Hereinafter, configuration units that have the same functions are denoted by the same reference numerals, and repeated description thereof will be omitted.

### Model Learning Device

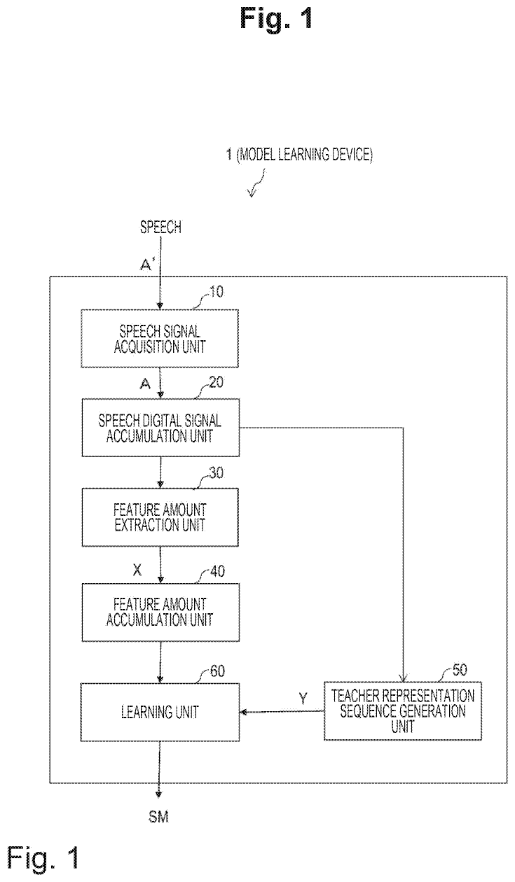

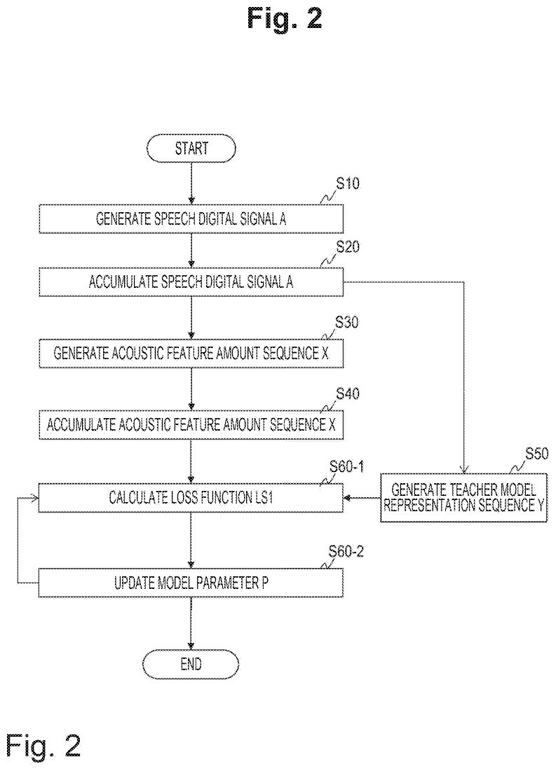

As illustrated in FIG. 1, the model learning device 1 according to the embodiment of the present disclosure includes, for example, a speech signal acquisition unit 10, a speech digital signal accumulation unit 20, a feature amount extraction unit 30, a feature amount accumulation unit 40, a teacher representation sequence generation unit 50, and a learning unit 60. The model learning device 1 implements the learning method according to the present embodiment by performing the processing illustrated in FIG. 2.

### (Speech Signal Acquisition Unit 10)

The speech signal acquisition unit 10 performs predetermined AD conversion processing on a speech signal (speech signal A′) that is an input analog signal to generate a speech digital signal (speech digital signal A), and outputs the generated speech digital signal to a speech digital signal accumulation unit 20 (step S10). The speech signal A′ is, for example, voice recorded by a PC microphone, an IC recorder, or the like. The speech signal A′ is not necessarily recorded in advance, and may be directly output to the speech signal acquisition unit 10 using a predetermined microphone or the like.

### (Speech Digital Signal Accumulation Unit 20)

The input speech digital signal A is accumulated and output to the feature amount extraction unit 30 and the teacher representation sequence generation unit 50 (step S20). The speech digital signal accumulation unit 20 may be configured as a part of the function of the speech signal acquisition unit 10.

### (Feature Amount Extraction Unit 30)

The feature amount extraction unit 30 generates an acoustic feature amount sequence (acoustic feature amount sequence X) for each utterance from the input speech digital signal A and outputs the generated acoustic feature amount sequence to the feature amount accumulation unit 40 (step S30).

As the acoustic feature amount sequence X to be generated, for example, 1 to 12 dimensions of mel-frequenct cepstrum coefficient (MFCC) based on short-time frame analysis of the speech digital signal A, dynamic parameters such as ΔMFCC and ΔΔMFCC which are dynamic feature amounts thereof, power, Δpower, ΔΔpower, and the like are used. Cepstrum mean normalization (CMN) processing may be performed on the MFCC. A logarithmic log mel filter bank (FBANK) may also be used. The acoustic feature amount sequence X is not limited to the MFCC or the power, and a parameter (for example, autocorrelation peak value, group delay, and the like) used for identifying a particular utterance may be used.

### (Feature Amount Accumulation Unit 40)

The feature amount accumulation unit 40 accumulates the acoustic feature amount sequence X input from the feature amount extraction unit 30, and outputs the acoustic feature amount sequence X to the learning unit 60 (step S40). The feature amount accumulation unit 40 may be configured as a part of the function of the feature amount extraction unit 30.

### (Teacher Representation Sequence Generation Unit 50)

The teacher representation sequence generation unit 50 generates a teacher model representation sequence (teacher model representation sequence Y) from the input speech digital signal A using a teacher model (teacher model TM), which is a trained model trained by self-supervised learning (SSL), and outputs the generated teacher model representation sequence Y to the learning unit 60 (step S50).

The teacher representation sequence generation unit 50 includes the teacher model TM which is a trained model trained by SSL. The teacher model IM includes, for example, a deep convolution layer (convolution layer N_{T}) and a multilayer encoder (encoder E_{T}). The teacher model TM may have another configuration as long as it is a trained model trained by SSL using a speech waveform as an input. The generated teacher model representation sequence Y may be only the last layer of the encoder or the representation sequence of all the intermediate layers.

### (Learning Unit 60)

A student model (student model SM) having a model size smaller than that of the teacher model TM is trained using the acoustic feature amount sequence X input from the feature amount accumulation unit 40 and the teacher model representation sequence Y input from the teacher representation sequence generation unit 50 (steps S60-1 and S60-2). The student model SM as the trained model is used for tasks such as voice recognition, speaker recognition, and emotion recognition, which are subsequent tasks described above, for example. The student model SM includes a convolution layer (convolution layer Ns) having a model size smaller than that of the convolution layer NT and an encoder (encoder Es) having a model size smaller than that of the encoder ET.

The learning unit 60 trains the student model SM using the acoustic feature amount sequence X as input data and using the teacher model representation sequence Y as labeled data (training data). The training of the student model SM is performed through the following processes (i) and (ii).
(i) A loss function (loss function LS1) is calculated using the acoustic feature amount sequence X as input data and the teacher model representation sequence Y as labeled data (step S60-1).
(ii) Based on the calculation result of the loss function LS1, a model parameter P included in the student model SM is updated (step S60-2). Examples of the loss function LS1 include a frame-based L1 loss function and cosine similarity, but other loss functions may be used.

The learning unit 60 repeats the above-described training using other data until the calculation result of the loss function LS1 satisfies a predetermined threshold, whereby the training is completed and the student model SM as a trained model is generated.

By the training in steps S60-1 and S60-2, the student model SM having a model size smaller than that of the teacher model TM is trained using the acoustic feature amount sequence X and the teacher model representation sequence Y. In the student model SM, as compared with the teacher model TM, the calculation cost is greatly reduced by three points: (i) the input sequence length is degenerated, (ii) the number of parameters (the number of layers or the number of dimensions) of the convolution layer is reduced, and (iii) the number of parameters is reduced by an arbitrarily determined encoder size. On the other hand, since the SSL representation of the teacher model TM is directly transferred to the student model SM, it is possible to minimize accuracy degradation in various subsequent tasks due to the pre-processed feature amount input.

In other words, the rich expression of the teacher model IM trained by the speech waveform is transferred to the student model SM having a small model size by knowledge distillation using the acoustic feature amount sequence X as input data. Therefore, the trained student model SM can ensure accuracy equivalent to that of the teacher model TM. As a result, it is possible to minimize accuracy degradation in various subsequent tasks associated with the input of the feature amount sequence such as the conventional FBANK.

As described above, the complicated speech representation can be realized by the student model SM having a model size smaller than that of the teacher model.

### Modification

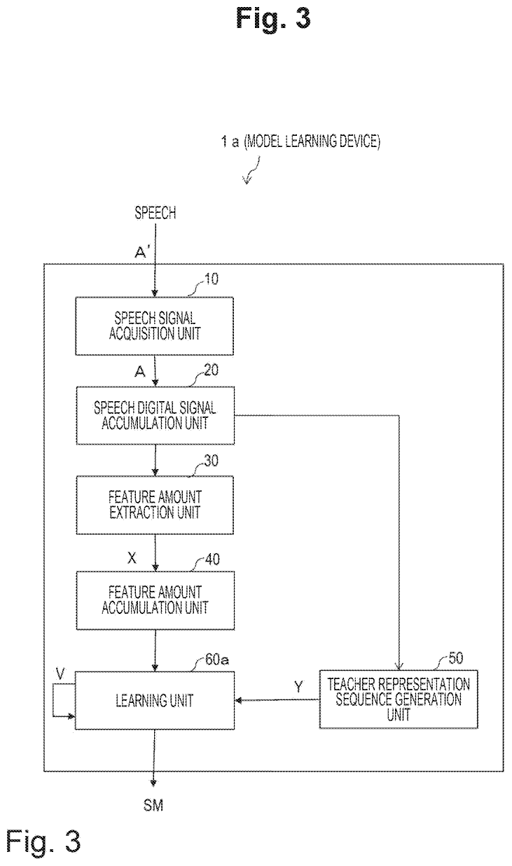

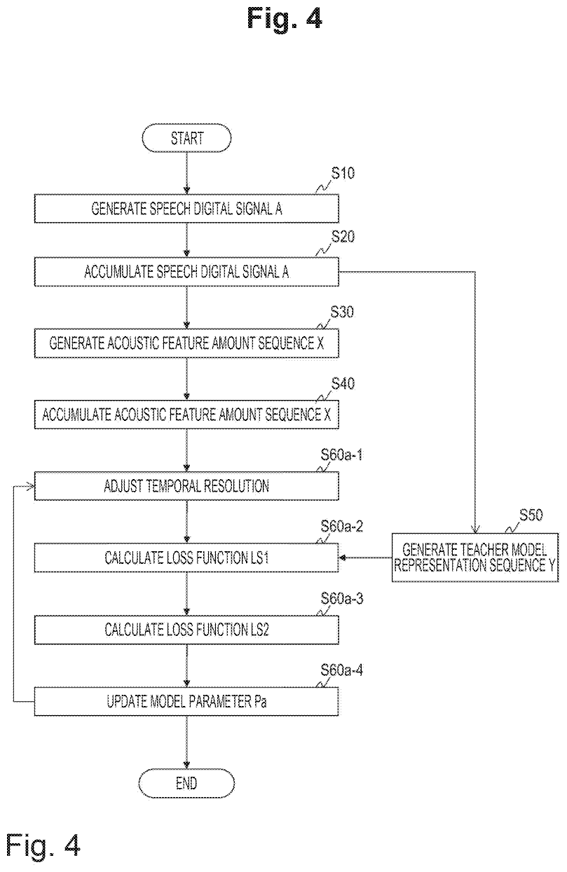

The model learning device 1 described above may be configured as the model learning device la illustrated in FIG. 3. In the model learning device la, the learning unit 60 of the model learning device 1 is replaced with the learning unit 60a. The model learning device la implements the learning method according to the present modification by performing the processing illustrated in FIG. 4.

The learning unit 60a has a student model SMa. The student model SMa further has a self-supervised learning function of generating a label (label V) from the acoustic feature amount sequence X in addition to the function of the student model SM described above. That is, the student model SMa is configured as a model for SSL.

At the time of training by the learning unit 60a, in addition to the knowledge distillation using the teacher model representation sequence Y as the labeled data, the label V generated from the acoustic feature amount sequence X as a result of training by the student model SMa as the SSL model may be used as the labeled data.

The learning unit 60a trains the student model SMa by performing the following processes (i) to (iv).

(i) As pre-processing of the loss function LS1, adjustment is performed to reduce the difference in temporal resolution between the acoustic feature amount sequence X and the teacher model representation sequence Y by adjusting at least one of the setting of the layer configuration of the convolution layer NT, the setting of the generation condition of the acoustic feature amount sequence X, and the setting of the convolution layer Ns layer configuration (step S60a-1).

When the knowledge distillation is performed using the teacher model representation sequence Y as the labeled data, there may be a case where a sequence length of the teacher model representation sequence Y is different from a sequence length generated by the student model SM. This occurs because the temporal resolution is different between the setting of the convolution layer N of the teacher model TM, the analysis condition of the acoustic feature amount sequence X, and the setting of the convolution layer (convolution layer N_{S}) of the student model SM. In order to solve this discrepancy, for example, the discrepancy is solved by adjusting the setting of the convolution layer N_{T}, the analysis condition of the acoustic feature amount sequence X, or the setting of the convolution layer Ng in order to match the temporal resolution. Furthermore, the temporal resolution may be adjusted by adding a transposed convolution layer to the SSL representation output by the student model SMa. However, the adjustment of the temporal resolution is merely an example, and the temporal resolution may be adjusted by other methods.

(ii) A loss function (loss function LS1) is calculated using the acoustic feature amount sequence X as input data and the teacher model representation sequence Y as labeled data (step S60a-2).

(iii) A loss function (loss function LS2) is calculated using the acoustic feature amount sequence X as input data and the label (label V) generated by the student model SMa as labeled data (step S60a-3). Examples of the loss function LS2 include wav2vec2.0 and the like, but other SSL methods may be used.

(iv) A model parameter Pa included in the student model SMa is updated based on the calculation result of the loss function LS1 and the calculation result of the loss function LS2 (step S60a-4). For example, a method of performing with a weighted sum of the loss function LS1 and the loss function LS2 can be considered, but another method may be used as long as both the loss functions can be considered.

The learning unit 60a repeats the above-described training using other data until the calculation results of the loss function LS1 and the loss function LS2 satisfy a predetermined threshold, whereby the training is completed and the student model SMa as a trained model is generated.

While the embodiment and the modification of the present disclosure have been described above, a specific configuration is not limited to the embodiment and the modification, and it goes without saying that an appropriate design change or the like not departing from the gist of the present disclosure is included in the present disclosure. The various types of processing described in the embodiment and the modification may be performed not only in chronological order in accordance with the described order, but also in parallel or individually depending on the processing capability of a device that performs the processing or as necessary.

### Program and Recording Medium

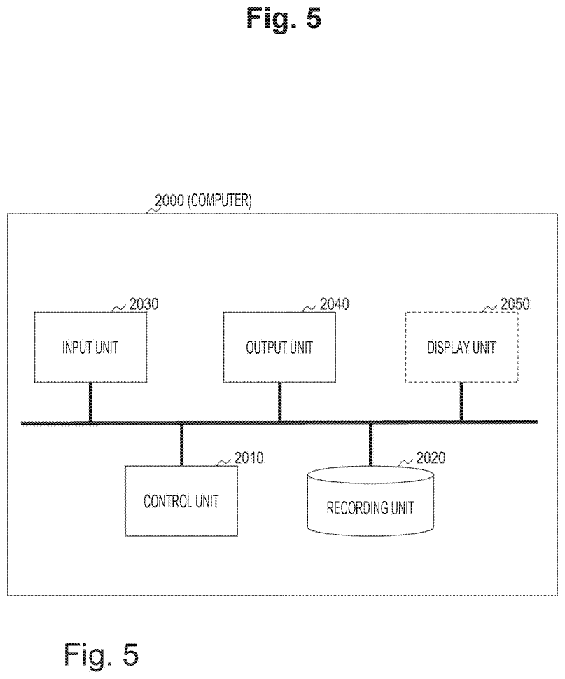

The various types of processing described above can be performed by causing a recording unit 2020 of a computer 2000 illustrated in FIG. 5 to read a program for executing each step of the method described above and causing a control unit 2010, an input unit 2030, an output unit 2040, a display unit 2050, and the like to operate.

The program in which the processing contents are written can be recorded on a computer-readable recording medium. The computer-readable recording medium may be, for example, any recording medium such as a magnetic recording device, an optical disc, a magneto-optical recording medium, or a semiconductor memory.

Furthermore, distribution of the program is performed by, for example, selling, transferring, or renting a portable recording medium such as a DVD or a CD-ROM on which the program is recorded. Moreover, the program may be stored in a storage device of a server computer, and the program may be distributed by being transferred from the server computer to another computer via a network.

For example, a computer that executes such a program first temporarily stores a program recorded on a portable recording medium or a program transferred from a server computer in a storage device of its own. Then, when executing processing, the computer reads the program stored in the recording medium of its own and executes the processing according to the read program. In addition, as another mode of executing the program, the computer may read the program directly from the portable recording medium and execute the processing according to the program, or may sequentially execute processing according to a received program every time the program is transferred from the server computer to the computer. In addition, the above-described processing may be executed by a so-called application service provider (ASP) type service that implements a processing function only by an execution instruction and result acquisition without transferring the program from the server computer to the computer.. Note that the program according to the present embodiment includes information used for processing by an electronic computer and equivalent to the program (data or the like that is not a direct command to the computer but has property that defines processing of the computer).

Furthermore, although the present device is configured by the predetermined program being executed on the computer in this mode, at least a part of the processing contents may be implemented by hardware.

### REFERENCE SIGNS LIST

1, 1a Model learning device
10 Speech signal acquisition unit
20 Speech digital signal accumulation unit
30 Feature amount extraction unit
40 Feature amount accumulation unit
50 Teacher representation sequence generation unit
60, 60a Learning unit
SM Student model
TM Teacher model
Speech signal
A′ Speech digital signal
E_{T}, E_{S} Encoder
LS1, LS2 Loss function
N_{T}, N_{S} Convolution layer
P, Pa Model parameter
V Label
X Acoustic feature amount sequence
Y Teacher model representation sequence

1. A model learning method comprising:
generating an acoustic feature amount sequence from a speech digital signal;
generating a teacher model representation sequence from the speech digital signal using a teacher model that is a trained model trained by self-supervised learning; and
training a student model having a model size smaller than a model size of the teacher model using the acoustic feature amount sequence and the teacher model representation sequence.

2. The learning method according to claim 1, wherein
the training includes:
calculating a first loss function using the acoustic feature amount sequence as input data and the teacher model representation sequence as labeled data; and
updating a model parameter included in the student model based on a calculation result of the first loss function.

3. The learning method according to claim 1, wherein
the student model further includes a self-supervised learning function of generating a label from the acoustic feature amount sequence, and
the training includes:
calculating a first loss function using the acoustic feature amount sequence as input data and the teacher model representation sequence as labeled data;
calculating a second loss function using the acoustic feature amount sequence as input data and a label generated by the student model as labeled data; and
updating a model parameter included in the student model based on a calculation result of the first loss function and a calculation result of the second loss function.

4. The learning method according to claim 3, wherein the training is performed using a weighted sum of the calculation result of the first loss function and the calculation result of the second loss function.

5. The learning method according to claim 1, wherein
the teacher model includes a first convolution layer and a first encoder, and
the student model includes a second convolution layer having a model size smaller than a model size of the first convolution layer, and a second encoder having a model size smaller than a model size of the first encoder.

6. The learning method according to claim 5, wherein in the training, as pre-processing of calculation of a first loss function, at least one of setting of a layer configuration of the first convolution layer, setting of a generation condition of the acoustic feature amount sequence, and setting of a layer configuration of the second convolution layers is adjusted to perform adjustment for reducing a difference in temporal resolution between the acoustic feature amount sequence and the teacher model representation sequence.

7. A model learning device comprising:
at least one processor; and
memory storing instructions that, when executed by the at least one processor, causes the device to perform a set of operations, the set of operations comprising:
generating an acoustic feature amount sequence from a speech digital signal;
generating a teacher model representation sequence from the speech digital signal using a teacher model that is a trained model trained by self-supervised learning; and
training a student model having a model size smaller than a model size of the teacher model using the acoustic feature amount sequence and the teacher model representation sequence.

8. A program for causing a computer to function as the model learning device according to claim 7.

9. The learning device according to claim 7, wherein
the training includes:
calculating a first loss function using the acoustic feature amount sequence as input data and the teacher model representation sequence as labeled data; and
updating a model parameter included in the student model based on a calculation result of the first loss function.

10. The learning method according to claim 7, wherein
the student model further includes a self-supervised learning function of generating a label from the acoustic feature amount sequence, and
the training includes:
calculating a first loss function using the acoustic feature amount sequence as input data and the teacher model representation sequence as labeled data;
calculating a second loss function using the acoustic feature amount sequence as input data and a label generated by the student model as labeled data; and
updating a model parameter included in the student model based on a calculation result of the first loss function and a calculation result of the second loss function.

11. The learning method according to claim 10, wherein the training is performed using a weighted sum of the calculation result of the first loss function and the calculation result of the second loss function.

12. The learning method according to claim 7, wherein
the teacher model includes a first convolution layer and a first encoder, and
the student model includes a second convolution layer having a model size smaller than a model size of the first convolution layer, and a second encoder having a model size smaller than a model size of the first encoder.

13. The learning method according to claim 12, wherein in the training, as pre-processing of calculation of a first loss function, at least one of setting of a layer configuration of the first convolution layer, setting of a generation condition of the acoustic feature amount sequence, and setting of a layer configuration of the second convolution layers is adjusted to perform adjustment for reducing a difference in temporal resolution between the acoustic feature amount sequence and the teacher model representation sequence.

14. A computer-readable non-transitory recording medium storing computer-executable program instructions that when executed by a processor cause a computer to execute a program generation method comprising:
generating an acoustic feature amount sequence from a speech digital signal;
generating a teacher model representation sequence from the speech digital signal using a teacher model that is a trained model trained by self-supervised learning; and
training a student model having a model size smaller than a model size of the teacher model using the acoustic feature amount sequence and the teacher model representation sequence.

15. The learning device according to claim 14, wherein
the training includes:
calculating a first loss function using the acoustic feature amount sequence as input data and the teacher model representation sequence as labeled data; and
updating a model parameter included in the student model based on a calculation result of the first loss function.

16. The learning method according to claim 14, wherein
the student model further includes a self-supervised learning function of generating a label from the acoustic feature amount sequence, and
the training includes:
calculating a first loss function using the acoustic feature amount sequence as input data and the teacher model representation sequence as labeled data;
calculating a second loss function using the acoustic feature amount sequence as input data and a label generated by the student model as labeled data; and
updating a model parameter included in the student model based on a calculation result of the first loss function and a calculation result of the second loss function.

17. The learning method according to claim 16, wherein the training is performed using a weighted sum of the calculation result of the first loss function and the calculation result of the second loss function.

18. The learning method according to claim 14, wherein
the teacher model includes a first convolution layer and a first encoder, and
the student model includes a second convolution layer having a model size smaller than a model size of the first convolution layer, and a second encoder having a model size smaller than a model size of the first encoder.

19. The learning method according to claim 18, wherein in the training, as pre-processing of calculation of a first loss function, at least one of setting of a layer configuration of the first convolution layer, setting of a generation condition of the acoustic feature amount sequence, and setting of a layer configuration of the second convolution layers is adjusted to perform adjustment for reducing a difference in temporal resolution between the acoustic feature amount sequence and the teacher model representation sequence.

20. The learning method according to claim 3, wherein the first loss function and the second loss function are calculated until a predetermined threshold is satisfied.
